(19) United States
(12) Patent Application Publication
(10) Pub. No.: US 2020/0064768 A1
(43) Pub. Date: Feb. 27, 2020

(54) METHOD OF ACTIVATING POST-PROCESSING APPARATUS CONNECTED TO IMAGE FORMING APPARATUS

(71) Applicant: CANON KABUSHIKI KAISHA, Tokyo (JP)

(72) Inventor: Naoki Ishikawa, Kashiwa-shi (JP)

(21) Appl. No.: 16/528,737

(22) Filed: Aug. 1, 2019

(30) Foreign Application Priority Data
Aug. 22, 2018 (JP) 2018-155686

(51) Int. Cl. G03G 15/00; G06F 3/12; B42C 1/12; B65H 37/04

(52) U.S. Cl. CPC G03G 15/6582; G06F 3/1278; B65H 2801/27; B65H 37/04; B42C 1/12

(57) ABSTRACT

A post-processing apparatus has an input terminal into which a first activation signal output from an image forming apparatus is input. A user switch is operated by a user. A generation circuitry is provided inside the post-processing apparatus. The generation circuitry, by turning on the user switch, generates a second activation signal corresponding to the first activation signal. A power source circuitry is activated in response to the first activation signal input into the input terminal. A post-processing mechanism performs a post-processing process on a sheet using an electric power supplied from the power source circuitry. When the image forming apparatus is in a state of being unable to output the first activation signal, in response to the second activation signal generated by the generation circuitry, the power source circuitry is activated.

### BACKGROUND OF THE INVENTION

### Field of the Invention

The present invention relates to a method of activating a post-processing apparatus connected to an image forming apparatus.

### Description of the Related Art

An image forming apparatus is connected to one or more post-processing apparatuses configured to apply various post-processing processes to a sheet. Examples of the post-processing processes include punching processing of performing punching holes in a sheet, bookbinding processing of binding sheets, stapling processing of stapling the sheets, and insertion processing of inserting front cover sheet, interleave sheet, and the like into bundle of sheets. Further, there are post-processing apparatuses for inspecting whether the image has been properly formed on a sheet. As illustrated by Japanese Patent Laid-Open No. 2003-155160, these post-processing apparatuses are controlled by an image forming apparatus.

Incidentally, there are user needs for using, in a standalone mode, the post-processing apparatuses connected to the image forming apparatus while the image forming apparatus is being stopped. For example, it would be convenient to be able to perform insertion processing or punching processing, and stapling processing on a sheet by activating the post-processing apparatuses alone without activating the image forming apparatus. Unfortunately, post-processing apparatuses in the related art are designed to be activated by an input of an activation signal from the image forming apparatus, and thus preclude the user from using the post-processing apparatuses by activating the post-processing apparatuses alone. The waiting time required for activating the image forming apparatus is generally longer than the time required for activating the post-processing apparatuses, and thus forces the user to wait for a long period of time.

### SUMMARY OF THE INVENTION

The present invention provides a post-processing apparatus connectable to an image forming apparatus. The post-processing apparatus may comprise the following elements. An input terminal into which a first activation signal output from the image forming apparatus is input. A user switch is operated by a user. A generation circuitry is provided inside the post-processing apparatus. The generation circuitry is configured, by turning on the user switch, to generate a second activation signal corresponding to the first activation signal. A power source circuitry is activated in response to the first activation signal input into the input terminal. A post-processing mechanism is configured to perform a post-processing process on a sheet using an electric power supplied from the power source circuitry. When the image forming apparatus is in a state of being unable to output the first activation signal, in response to the second activation signal generated by the generation circuitry, the power source circuitry is activated.

Further features of the present invention will become apparent from the following description of exemplary embodiments (with reference to the attached drawings).

### BRIEF DESCRIPTION OF THE DRAWINGS

FIGS. 1A and 1B are views for illustrating an image forming system.

FIGS. 2A and 2B are views for illustrating an image forming system.

FIG. 3 is a view for illustrating a controller.

FIG. 4 is a view for illustrating a power source.

FIG. 5 is a chart illustrating an activation sequence in a first operation mode.

FIG. 6 is a chart illustrating an activation sequence in a second operation mode.

FIGS. 7A and 7B are diagrams illustrating a transmission of a processing instruction.

FIGS. 8A and 8B are diagrams illustrating signal sequences performed within an image forming system.

FIG. 9 is a flowchart for illustrating an activation processing.

FIG. 10 is a diagram for illustrating functions of a CPU.

### DESCRIPTION OF THE EMBODIMENTS

Hereinafter, embodiments will be described in detail with reference to the accompanying drawings. Note that the following embodiments are not intended to limit the invention recited in the claims. Although the embodiments describe a plurality of features, all of the plurality of features are not necessarily indispensable for the invention, and the plurality of features may be combined in any way. Moreover, in the accompanying drawings, the same reference numerals denote the same or similar configurations, and redundant descriptions thereof will be omitted.

### Image Forming System

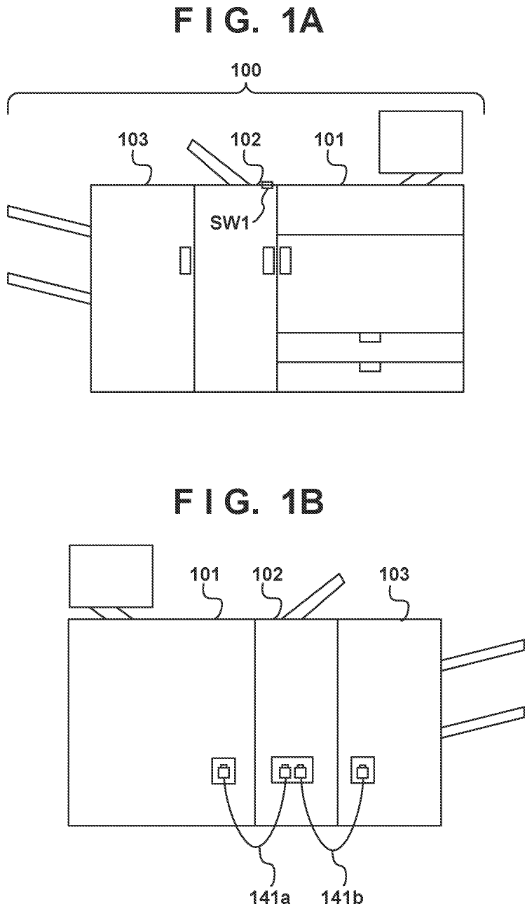

FIG. 1A is a front view illustrating an image forming system 100 that includes an image forming apparatus 101 and one or more post-processing apparatuses. As the one or more post-processing apparatuses, an inserter 102 and a finisher 103 are illustrated. In the transport direction of the sheet, the inserter 102 is connected to the downstream side of the image forming apparatus 101. The finisher 103 is connected to the downstream side of the inserter 102. The inserter 102 and the finisher 103 performs post-processing processes on the sheet that is output from the image forming apparatus 101. The inserter 102 causes insertion sheet (e.g., front cover sheet or inner sheet, and back cover sheet) to be inserted into a sheet group that is output from the image forming apparatus 101. The finisher 103 performs punching processing or stapling processing on the sheet group that is output from the image forming apparatus 101. Further, the finisher 103 may perform a post-processing process on the sheet group containing the insertion sheet that has been inserted by the inserter 102.

Switching a main switch (not illustrated) from OFF to ON causes the image forming apparatus 101 to be activated. Moreover, the image forming apparatus 101 outputs activation signals to the inserter 102 and the finisher 103, to then cause the inserter 102 and the finisher 103 to be activated. When the image forming apparatus 101 is in a power source OFF state or a power saving state, the image forming apparatus 101 cannot output the activation signal. The power source OFF state and the power saving state may be alternatively referred to as output disabled state of activation signal. Hereinafter, for simplifying the descriptions, the output disabled state is designated as power source OFF state.

In order to enable the inserter 102 and the finisher 103 to be activated even when the image forming apparatus 101 is in the power source OFF state, the inserter 102 is provided with a mechanical switch SW1. The mechanical switch SW1 is required to be a switch that is turned on and off on the basis of a user operation, and may be a see-saw switch or a semiconductor switch. Note that, in case of the semiconductor switch, a power source and the like for applying a control signal in response to a user operation is required separately. The inserter 102 is provided with a generation circuitry configured to generate an activation signal of pseudo signal in place of the image forming apparatus 101 on the basis of the operation of the mechanical switch SW1. This enables the inserter 102 and the finisher 103 to be activated. Note that the state where the inserter 102 and the finisher 103 are activated is a state where a post-processing process is enabled to be performed. Note that the state of the post-processing apparatus when the image forming apparatus 101 is in the power source OFF state may also be referred to as an offline state. The state of the post-processing apparatus when the image forming apparatus 101 is in the power source ON state may be referred to as an online state as well.

Since the inserter 102 and the finisher 103 are operable in the offline state, a post-processing process can be performed without activating the image forming apparatus 101. For example, the user can cause, by causing the sheet group on which the images have already been formed (outcoming product) to be fed from the inserter 102 to the finisher 103, a post-processing process to be performed on the sheet group. The outcoming product may have been generated by the image forming apparatus 101 or may have been generated by another image forming apparatus.

FIG. 1B is a back view of the image forming system 100. A communication cable 141a includes, for example, a communication line that communicably connects the image forming apparatus 101 and the inserter 102, and a signal line for transmitting the activation signal. A communication cable 141b includes, for example, a communication line that communicably connects the inserter 102 and the finisher 103, and a signal line for transmitting the activation signal. Moreover, the communication cable 141a and the communication cable 141b make the image forming apparatus 101 and the finisher 103 communicable with each other. The communication cables 141a and 141b may include one or more communication lines that transmit serial signals or parallel signals.

### Sheet Transportation

### Transport Operation of Image Forming Apparatus 101

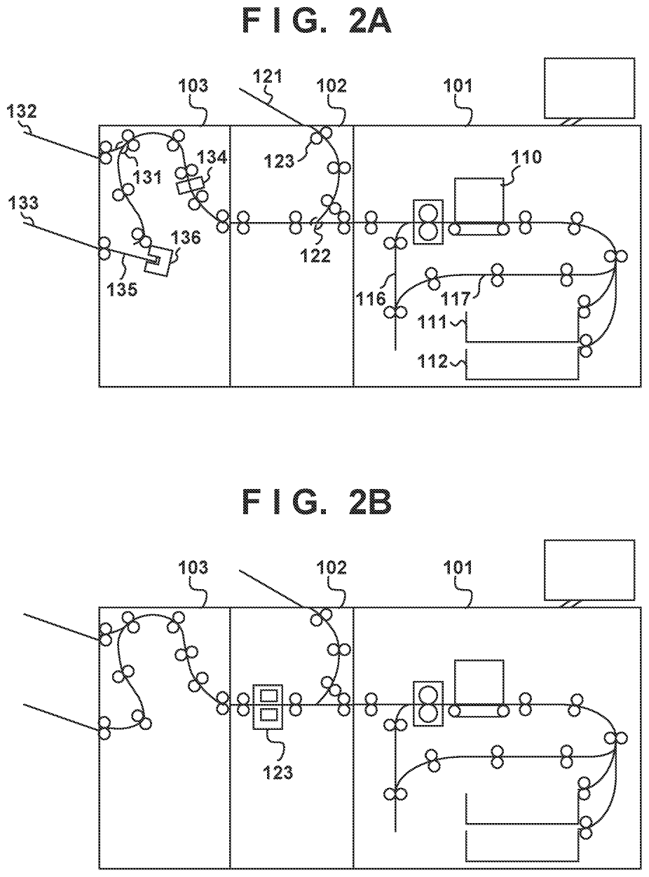

The sheet transport operation of the image forming system 100 is described with reference to FIG. 2A. The image forming apparatus 101 includes paper feed trays 111 and 112 for feeding a sheet to a transport path. An image forming unit 110 forms an image on the sheet. The image forming method of the image forming unit 110 may be of any method such as electro-photography type and inkjet type. The sheet on which the image has been formed by the image forming unit 110 is output to the inserter 102. The image forming apparatus 101 may have a double-sided printing mode. The image forming unit 110, when the double-sided printing mode is commanded, forms an image on the first surface of the sheet and transports the sheet to a reverse path 116. The reverse path 116 reverses the transport direction of the sheet and transports the sheet to a double-sided path 117. The double-sided path 117 feeds the sheet to the image forming unit 110 again. The image forming unit 110 forms an image on the second surface of the sheet and outputs the sheet to the inserter 102.

### Transport Operation of Inserter 102

The inserter 102 receives the sheet from the image forming apparatus 101, transports the sheet, and then discharges the sheet into the finisher 103. The inserter 102 includes an inserter tray 121 for inserting the insertion sheet before or after the sheet received from the image forming apparatus 101. The inserter tray 121 stacks one or more insertion sheets. The feeding roller 124 feeds the insertion sheets stacked on the inserter tray 121 one by one to a converging section 122. This allows the insertion sheet to be inserted into any position (page) in the sheet group that is output from the image forming apparatus 101. The inserter 102 transports the sheet from the image forming apparatus 101 and the insertion sheet inserted at the converging section 122, respectively, and discharges the sheet and the insertion sheet to the finisher 103. As such, the inserter tray 121 and the feeding roller 124 form a sheet insertion mechanism.

### Transport Operation of Finisher 103

The finisher 103 receives the sheet and the insertion sheet having been fed from the inserter 102, performs a post-processing process on the sheet and the insertion sheet as necessary, and discharges the sheet and the insertion sheet into an upper discharge tray 132 or a lower discharge tray 133. A switching unit 131 includes a flapper or the like that switches the discharge destination of the sheet (the upper discharge tray 132 or the lower discharge tray 133).

A punching unit 134 performs punching processing on the sheet that is output from the inserter 102. A stapler 136 performs stapling processing on a sheet bundle (sheet group) that is output from the inserter 102 and stacked on a staple tray 135, and then discharges the sheet into the lower discharge tray 133.

### Inspection Apparatus

As illustrated in FIG. 2B, the inserter 102 may include inspection apparatus 123 for inspecting images formed in the sheet. The inspection apparatus 123 measures and performs inspection on, for example, the deviation amount between the formation position of the image formed on a sheet and the target position, the deviation amount between the concentration of the image and the target concentration, and the like. The inspection apparatus 123 includes, for example, an imaging element that reads out an image. The inserter 102 may perform inspection on the outcoming product on the basis of the reading out result of the imaging element, determine whether the outcoming product satisfies the acceptance criterion, and control the switching unit 131 of the finisher 103 in accordance with the determination result. For example, the outcoming product having satisfied the acceptance criterion may be discharged into the upper discharge tray 132, while the outcoming product that does not satisfy the acceptance criterion may be discharged into the lower discharge tray 133.

### Controller

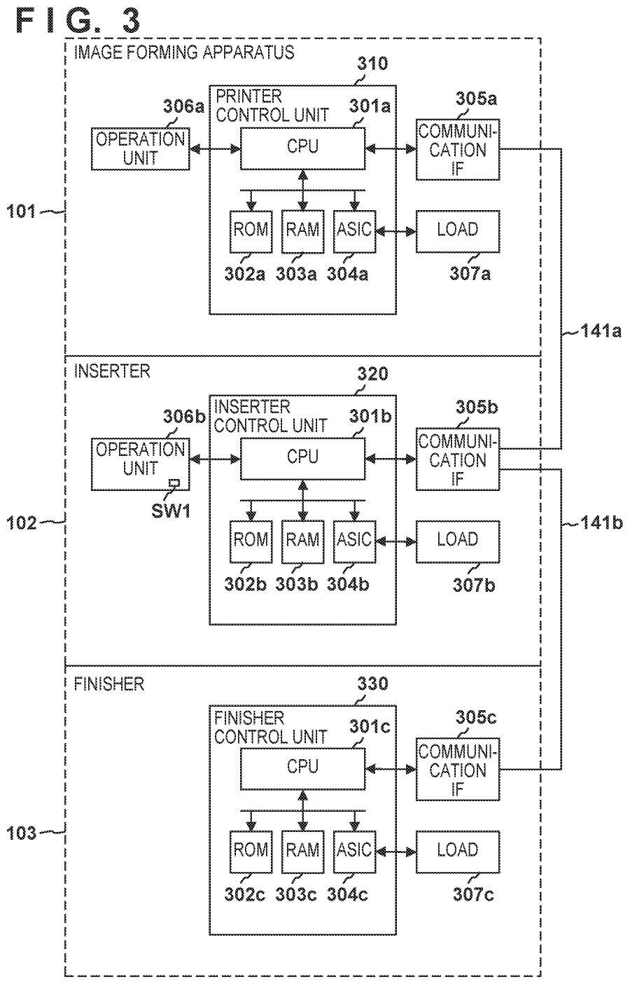

A control unit of the image forming system is described with reference to FIG. 3. The image forming apparatus 101 controls one or more post-processing apparatuses that is directly or indirectly connected to the image forming apparatus 101. When the image forming apparatus 101 is not activated (in a power source OFF state), the post-processing apparatus that is located farthest upstream in the transport direction of the sheet assumes a master. The post-processing apparatus assuming the master activates and controls another post-processing apparatus that is located farther downstream.

### Controller of Image forming apparatus 101

A printer control unit 310 includes a CPU 301a, a ROM 302a, a RAM 303a, and an ASIC 304a. The CPU is an abbreviation for Central Processing Unit. The ROM is an abbreviation for Read Only Memory. The RAM is an abbreviation for Random Access Memory. The ASIC is an abbreviation for Application Specific Integrated Circuit. The CPU 301a executes a control program stored in the ROM 302a to control the image forming apparatus 101, the inserter 102, and the finisher 103. The ROM 302a is a non-volatile memory. The RAM 303a is a volatile memory. The ASIC 304a controls a load section 307a in accordance with an instruction from a CPU 301b. The load section 307a includes a motor for driving the image forming unit 110, a sheet feeding transporting part, and the like. An operation unit 306a includes an input device and a display device. The user inputs a command to the CPU 301a through the input device. The CPU 301a causes the display device to display the results of execution of the command. A communication I/F 305a includes a communication circuitry and a signal input/output circuitry. The CPU 301a communicates with the inserter 102 and the finisher 103 through the communication I/F 305a. The CPU 301a sends an instruction in accordance with the job designated by the user to the inserter 102 and the finisher 103 through the communication I/F 305a. The communication cable 141a connected to the communication I/F 305a includes, for example, a signal line for transmitting High/Low and a communication line that transmits communication signals. Any communication method such as serial communication method or parallel communication method can be employed as the communication method of the communication I/F 305a. The communication I/F 305a sends data and commands to the inserter 102 and the finisher 103, with appending IDs (identification information) stored in the ROM 302a. Examples of the commands include an activation signal for activating the inserter 102 or the finisher 103. The activation signal may be referred to as power source ON signal or power source remote signal.

### Controller of Inserter 102

An inserter control unit 320 includes the CPU 301b, a ROM 302b, a RAM 303b, and an ASIC 304b. The CPU 301b executes a control program stored in the ROM 302b to control the inserter 102. The ROM 302b is a non-volatile memory. The RAM 303b is a volatile memory. The ASIC 304b controls a load section 307b in accordance with an instruction from the CPU 301b. The load section 307b includes a sheet-feeding unit that pauses an insertion sheet, a motor for driving a transport unit that transports the insertion sheet, the sheet from the image forming apparatus 101 and the like. An operation unit 306b includes an input device and a display device. The user inputs a command to the CPU 301b through the input device. The CPU 301b causes the display device to display the results of execution of the command. Note that the mechanical switch SW1 may be a part of the operation unit 306b as well. A communication I/F 305b includes a communication circuitry and a signal input/output circuitry. The CPU 301b communicates with the image forming apparatus 101 and the finisher 103 through the communication I/F 305b. The CPU 301b sends an instruction in accordance with the job designated by the user to the finisher 103 through the communication I/F 305b. The communication cables 141a and 141b connected to the communication I/F 305b include, for example, a signal line for transmitting High/Low and a signal line that transmits a communication signal. Any communication method such as serial communication method or parallel communication method can be employed as the communication method of the communication I/F 305b. The communication I/F 305b sends data and commands to the image forming apparatus 101 and the finisher 103 with appending IDs (identification information) stored in the ROM 302b. Examples of the commands include an activation signal (power source ON signal) for activating the finisher 103. A communication I/F 305c also receives an activation signal (power source ON signal) for activating the inserter 102 from the image forming apparatus 101. Examples of the data include configuration information of the inserter 102 stored in the ROM 302b and the like. The configuration information is information for identifying the functions of the inserter 102 (e.g., the number of inserter trays).

### Controller of Finisher 103

A finisher control unit 330 includes a CPU 301c, a ROM 302c, a RAM 303c, and an ASIC 304c. The CPU 301c controls the finisher 103 by executing a control program stored in the ROM 302c. The ROM 302c is a non-volatile memory. The RAM 303c is a volatile memory. The ASIC 304c controls a load section 307c in accordance with the instruction from the CPU 301c. The load section 307c includes the punching unit 134 and the stapler 136, a solenoid that drives the switching unit 131, a motor for driving a transport roller, and the like. The communication I/F 305c includes a communication circuitry and a signal input/output circuitry. The CPU 301c communicates with the image forming apparatus 101 and the inserter 102 through the communication I/F 305c. Any communication method such as serial communication method or parallel communication method can be used for the communication method of the communication I/F 305c. The communication I/F 305c sends data with appending IDs (identification information) stored in the ROM 302c to the image forming apparatus 101 and the inserter 102. The communication I/F 305c receives an activation signal (power source ON signal) for activating the finisher 103 from the image forming apparatus 101 or the inserter 102. Examples of the data include configuration information of the finisher 103 stored in the ROM 302c and the like. The configuration information is information for identifying functions of the finisher 103 (e.g., types of performable post-processing processes and number of discharge trays).

### Power Source Configuration

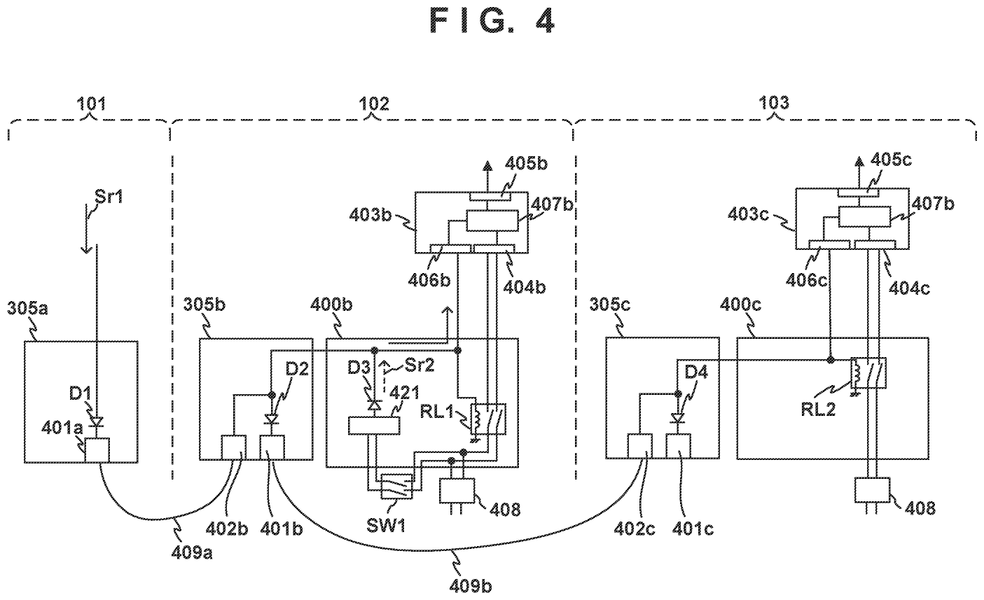

A power source configuration of the image forming system 100 is described with reference to FIG. 4. The communication cable 141a that connects the image forming apparatus 101 and the inserter 102 is provided with a signal line 409a for transmitting a power source remote signal Sr1. The communication cable 141b that connects the inserter 102 and the finisher 103 is provided with a signal line 409b for transmitting the power source remote signal Sr1.

The power source remote signal Sr1 generated by the CPU 301a is output via a diode D1 and a signal output terminal 401a that are provided in the communication I/F 305a. The anode of the diode D1 is connected to the CPU 301a, and the cathode of the diode D1 is connected to the signal output terminal 401a. The diode D1 is a rectification element for regulating a signal flowing back from the inserter 102. The signal output terminal 401a is connected to the signal line 409a.

The communication I/F 305b of the inserter 102 includes a signal input terminal 402b for inputting the power source remote signal Sr1 and a signal output terminal 401b for outputting the power source remote signal Sr1. The signal input terminal 402b, which is connected to the signal line 409a, receives the power source remote signal Sr1 that is output from the image forming apparatus 101. The signal input terminal 402b is connected to the anode of a diode D2. The cathode of the diode D2 is connected to the signal output terminal 401b. The diode D2 is a rectification element that causes the power source remote signal Sr1 input from the signal input terminal 402b to pass to the signal output terminal 401b, and regulates a signal that flows into the signal output terminal 401b from the finisher 103.

An alternating-current driver 400b is a circuitry for inputting an alternating current from an alternating-current power source 408. The alternating-current power source 408 may be a commercial alternating-current power source, and may be a power source connector connected to the commercial alternating-current power source as well. A DC power source 403b is a power source circuitry configured to convert the alternating current supplied via the alternating-current driver 400b into a direct current, and to supply the direct current to the inserter control unit 320 and the load section 307b. The DC power source 403b includes a remote input unit 406b for inputting the power source remote signal Sr1, an alternating-current input unit 404b for inputting the alternating current that is output from the alternating-current driver 400b, and a DC output unit 405b for outputting a direct current. The DC power source 403b includes a conversion circuitry 407b configured to convert the alternating current into a direct current.

The alternating-current driver 400b includes a relay RL1. The control terminal of the relay RL1 is connected to the signal input terminal 402b. Upon input of the power source remote signal Sr1 generated by the image forming apparatus 101 into the control terminal of the relay RL1, the relay RL1 is switched from OFF (non-conduction state) to ON (conduction state), and supplies the alternating current to the DC power source 403b. That is, the power source remote signal Sr1 serves as a drive signal for energizing the drive coil of the relay RL1. In a case where the power source remote signal Sr1 is not input into the control terminal of the relay RL1, the relay RL1 is turned off and does not supply the alternating current to the DC power source 403b.

As described above, there are user needs for activating the post-processing apparatus without activating the image forming apparatus 101. The power source remote signal Sr1 is generated when the image forming apparatus 101 is in the power source ON state. In the related art, in order to use a post-processing apparatus, the image forming apparatus 101 is inevitably required to be activated. In view of the above, in this example, the mechanical switch SW1 and a generation circuitry 421 are added. The mechanical switch SW1 is a switch for supplying an alternating current supplied from the alternating-current power source 408 to the generation circuitry 421 or blocking the alternating current. The generation circuitry 421 is a circuitry that generates a power source remote signal Sr2 of pseudo signal by converting an alternating current supplied via the mechanical switch SW1. The power source remote signal Sr2 has electrical properties equivalent to the power source remote signal Sr1 that is generated by the image forming apparatus 101. Accordingly, the power source remote signal Sr2 may be alternatively designated as the power source remote signal Sr1. The generation circuitry 421 outputs the power source remote signal Sr2 to the control terminal of the relay RL1, the remote input unit 406b of the DC power source 403b, and the signal output terminal 401b. The relay RL1, upon supply of the power source remote signal Sr2 of pseudo signal, is switched from OFF to ON, and supplies the alternating current to the DC power source 403b. The DC power source 403b, upon input of the power source remote signal Sr2 of pseudo signal, initiates a process of converting the alternating current into a direct current. This allows for an activation of the inserter 102. Further, the signal output terminal 401b also activates the finisher 103 to provide the power source remote signal Sr2 of pseudo signal, via the signal line 409b, to the finisher 103.

The anode of a diode D3 is connected to the generation circuitry 421. The cathode of the diode D3 is connected to the signal input terminal 402b, the signal output terminal 401b, the control terminal of the relay RL1, and the remote input unit 406b. In particular, the diode D3 is a rectification element configured to regulate a power source remote signal from flowing into the generation circuitry 421, the power source remote signal being applied to the signal input terminal 402b from the image forming apparatus 101. As such, the generation circuitry 421 generates the power source remote signal Sr1 in place of the image forming apparatus 101.

The communication I/F 305c of the finisher 103 includes a signal input terminal 402c for inputting the power source remote signal Sr1 and a signal output terminal 401c for outputting the power source remote signals Sr1 and Sr2. The signal output terminal 401c is used in outputting the power source remote signals Sr1 and Sr2 to another post-processing apparatus that is located downstream of the finisher 103. The signal input terminal 402c, which is connected to the signal line 409b, receives the power source remote signal Sr1 that is generated by the image forming apparatus 101, or the power source remote signal Sr2 that is generated by the inserter 102. The signal input terminal 402c is connected to the anode of a diode D4. The cathode of the diode D4 is connected to the signal output terminal 401c. The diode D4 is a rectification element that causes the power source remote signal Sr1 and the power source remote signal Sr2 that are input from the signal input terminal 402c to pass to the signal output terminal 401c, and regulates the signals that flow from another post-processing apparatus into the signal output terminal 401c.

An alternating-current driver 400c is a circuitry for inputting alternating current from the alternating-current power source 408. A DC power source 403c is a power source circuitry configured to convert the alternating current supplied via the alternating-current driver 400c into a direct current, and to supply the direct current to the finisher control unit 330 and the load section 307c. The DC power source 403c includes a remote input unit 406c for inputting the power source remote signals Sr1 and Sr2, an alternating-current input unit 404c for inputting the alternating current that is output from the alternating-current driver 400c, and a DC output unit 405c for outputting a direct current. A conversion circuitry 407c is a circuitry configured to convert the alternating current into a direct current during a period in which the power source remote signals Sr1 and Sr2 are being input.

The alternating-current driver 400c includes a relay RL2. The signal input terminal 402c is connected to the control terminal of the relay RL2. Upon input of the power source remote signals Sr1 and Sr2 generated by the image forming apparatus 101 or the inserter 102 into the control terminal of the relay RL2, the relay RL2 is switched from OFF (non-conduction state) to ON (conduction state), and then supplies the alternating current to the DC power source 403c. That is, the power source remote signals Sr1 and Sr2 serve as a drive signal for energizing the drive coil of the relay RL2. In a case where the power source remote signals Sr1 and Sr2 are not input into the control terminal of the relay RL2, the relay RL2 is turned off and does not supply the alternating current to the DC power source 403c.

The signal input terminal 402c is connected to the remote input unit 406c via an internal signal line. The internal signal line is connected to the anode of the diode D4, the drive coil (control terminal) of the relay RL2, and the remote input unit 406c. The DC power source 403c, upon input of the power source remote signal Sr1 generated by the image forming apparatus 101 or the inserter 102 into the DC power source 403c, initiates a process of converting the alternating current into a direct current. This allows for an activation of the finisher 103.

### Activation Sequence

Hereinafter, an activation sequence of the image forming system 100 for each of the operation modes will be described. The first operation mode is an operation mode in which the post-processing apparatus is activated by the power source remote signal Sr1 generated by the activation of the image forming apparatus 101. The second operation mode is an operation mode in which the image forming apparatus 101 is not activated while the post-processing apparatus is activated.

### First Operation Mode

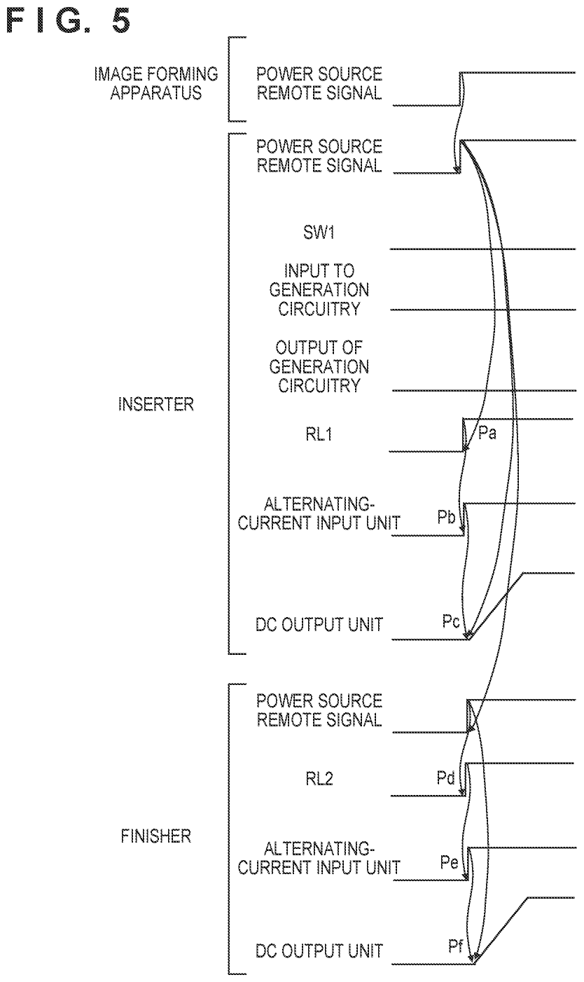

FIG. 5 illustrates the first operation mode (first activation sequence). The CPU 301a of the image forming apparatus 101 starts outputting of the power source remote signal Sr1 when activated upon being electrically powered from a commercial power source.

Upon output of the power source remote signal Sr1 from the image forming apparatus 101, the power source remote signal Sr1 is input into the inserter 102. The power source remote signal Sr1 is supplied to the remote input unit 406b of the DC power source 403b of the inserter 102 and the drive coil of the relay RL1. As indicated by Pa, the power source remote signal Sr1 causes the relay RL1 to be switched from OFF to ON. As indicated by Pb, an alternating voltage is supplied to the DC power source 403b. The power source remote signal Sr1 is being input into the remote input unit 406b of the DC power source 403b. As indicated by Pc, the DC output unit 405b of the DC power source 403b starts outputting of a direct current (DC) voltage. The activation of the DC power source 403b causes the inserter control unit 320 to be activated, allowing the user to be able to use the inserter 102.

The power source remote signal Sr1 generated by the image forming apparatus 101 is supplied to the remote input unit 406b of the DC power source 403c of the finisher 103 and the drive coil of the relay RL2 as well. As indicated by Pd, the power source remote signal Sr1 causes the relay RL2 to be switched from OFF to ON. As indicated by Pe, an alternating voltage is thereby supplied to the DC power source 403c as well. A power source remote signal Sr1 is being input into the remote input unit 406c of the DC power source 403c. Accordingly, as indicated by Pf, the DC output unit 405c of the DC power source 403c outputs a direct current voltage. The activation of the finisher control unit 330 causes the DC power source 403c to be activated. This allows the user to be able to use the finisher 103. As such, in the first operation mode, the inserter 102 and the finisher 103 are activated by the power source remote signal Sr1 that is output from the image forming apparatus 101.

### Second Operation Mode

When the mechanical switch SW1 of the inserter 102 is switched on during the power source OFF state of the image forming apparatus 101, the inserter 102 operates in the second operation mode. In the descriptions below, the image forming apparatus 101 is not activated, that is, the image forming apparatus 101 is stopped.

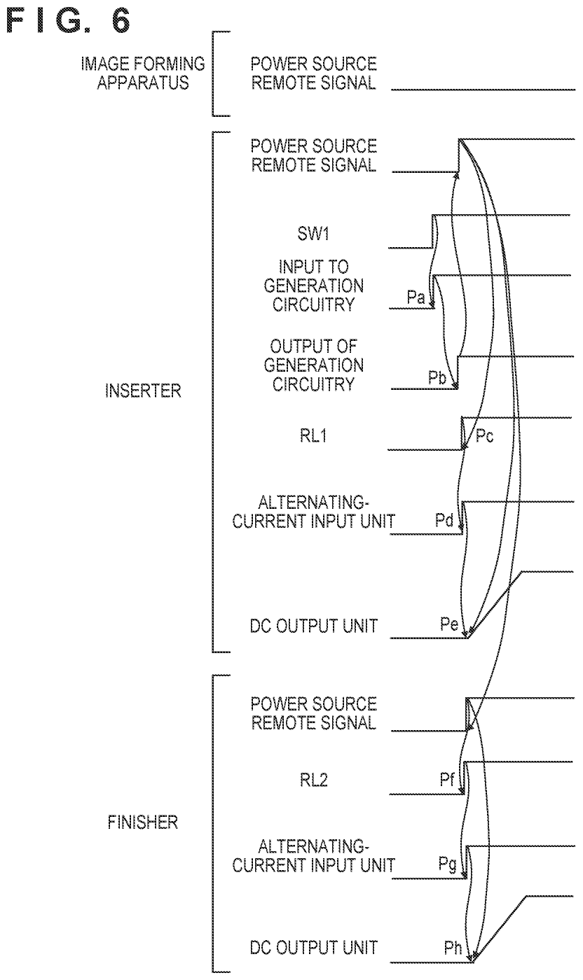

As illustrated in FIG. 6, the mechanical switch SW1 is switched from OFF to ON. As indicated by Pa, an alternating current is supplied to the generation circuitry 421 via the mechanical switch SW1. As indicated by Pb, the generation circuitry 421 starts generating of the power source remote signal Sr2 of pseudo signal on the basis of the alternating current. The power source remote signal Sr2 is input into the remote input unit 406b of the DC power source 403b, the drive coil of the relay RL1, and the signal output terminal 401b.

As indicated by Pc, the power source remote signal Sr2 causes the relay RL1 to be switched from OFF to ON. As indicated by Pd, the relay RL1 supplies an alternating voltage to the DC power source 403b. The power source remote signal Sr2 generated by the generation circuitry 421 is being input into the remote input unit 406b of the DC power source 403b. Accordingly, as indicated by Pe, the DC output unit 405c of the DC power source 403b starts outputting of a direct current voltage. The activation of the inserter control unit 320 causes the DC power source 403b to be activated. This allows the user to be able to use the inserter 102.

The generation circuitry 421 supplies the power source remote signal Sr2, via the diodes D3 and D2, to the finisher 103. The power source remote signal Sr2 having been supplied to the finisher 103 is supplied to the remote input unit 406c of the DC power source 403c and the drive coil of the relay RL2 as well. As indicated by Pf, the power source remote signal Sr2 causes the relay RL2 to be switched from OFF to ON. As indicated by Pg, the relay RL2 supplies an alternating voltage to the DC power source 403c. The power source remote signal Sr2 generated by the inserter 102 is being input into the remote input unit 406c of the DC power source 403c. Accordingly, as indicated by Ph, the DC output unit 405c of the DC power source 403c starts outputting of a direct current voltage. The activation of the DC power source 403c causes the finisher control unit 330 to be activated, allowing the user to use the finisher 103. As such, the post-processing apparatus is enabled to be activated even when the image forming apparatus 101 is in the power source OFF state.

### Control of Finisher by Inserter

### First Operation Mode

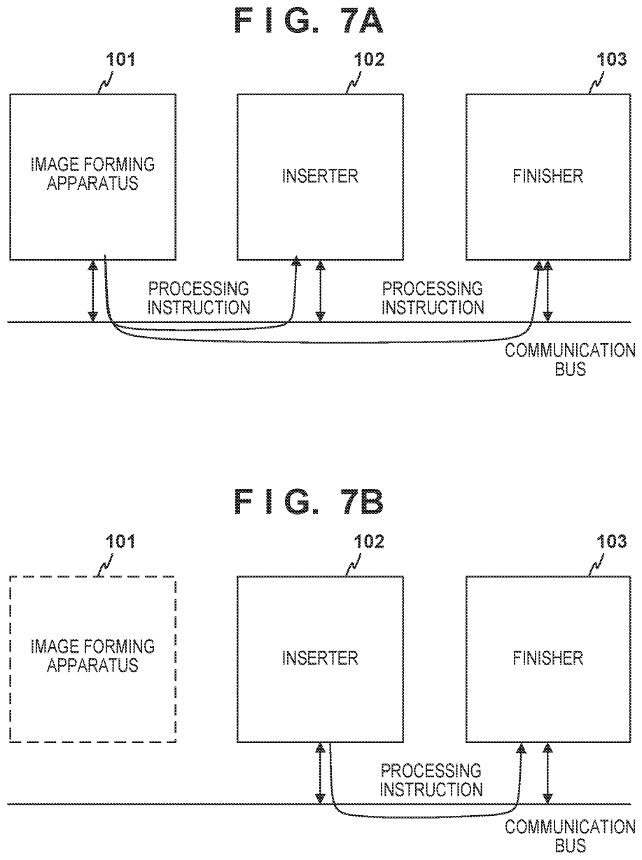

FIG. 7A illustrates a transmission and reception of processing instructions in a state where the image forming apparatus 101, the inserter 102, and the finisher 103 are each activated. The communication line included in the communication cables 141a and 141b forms a communication bus. The inserter 102 and the finisher 103 activated by the power source remote signal Sr1 each perform a post-processing process on the basis of the processing instruction sent from the image forming apparatus 101. The CPU 301a of the image forming apparatus 101 generates a processing instruction on the basis of the information that is input into the operation unit 306a, and sends the processing instruction to the post-processing apparatus on which the processing is to be performed. Upon reception of a processing instruction addressed to the inserter 102, the CPU 301b of the inserter control unit 320 controls the load section 307b in accordance with the processing instruction to perform a post-processing process (e.g., insertion of the insertion sheet or inspection of the outcoming product). Similarly, upon reception of a processing instruction addressed to the finisher 103, the CPU 301c of the finisher control unit 330 controls the load section 307c in accordance with the processing instruction to perform a post-processing process (e.g., punching processing or stapling processing).

### Second Operation Mode

FIG. 7B illustrates a case in which the image forming apparatus 101 is in a non-connected state or a non-activated state, and the inserter 102 and the finisher 103 are in an activated state. This case is a case in which the inserter 102 and the finisher 103 are activated by the power source remote signal Sr2 due to the switching of the mechanical switch SW1 of the inserter 102 from OFF to ON.

Since the image forming apparatus 101 is not activated or not connected, the inserter 102 generates a processing instruction and sends the processing instruction to the finisher 103 in place of the image forming apparatus 101. Note that the CPU 301b of the inserter control unit 320 generates the processing instruction on the basis of information that is input from the operation unit 306b. Upon reception of a processing instruction addressed to the finisher 103, the CPU 301c of the finisher 103 controls the load section 307c in accordance with the processing instruction to perform a post-processing process (e.g., punching processing or stapling processing).

### Signal Sequence

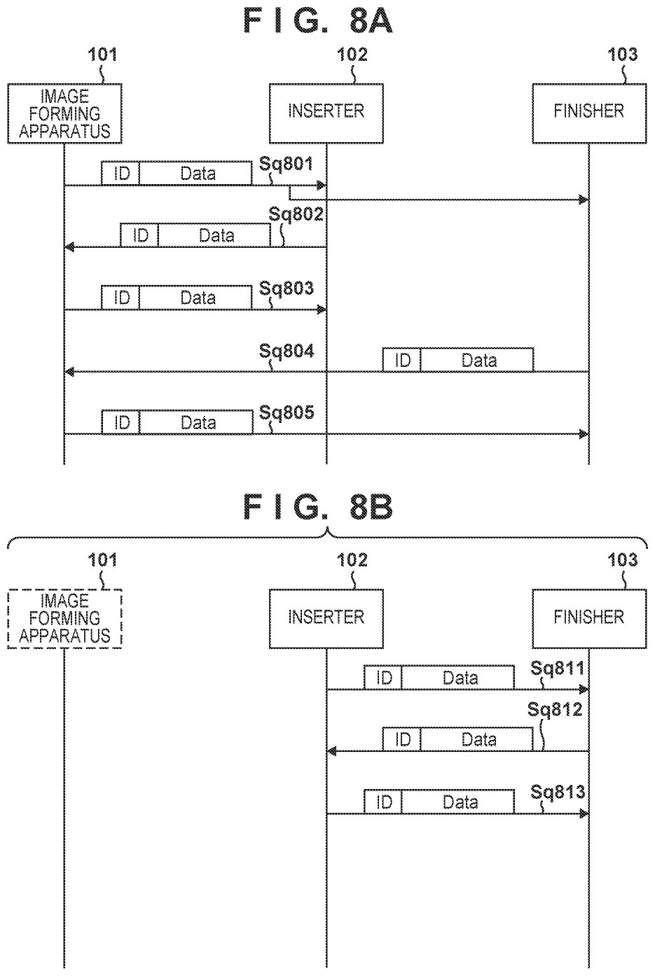

FIG. 8A illustrates a signal sequence in the image forming system 100 connected with the image forming apparatus 101, the inserter 102, and the finisher 103. The following sequence starts upon activation of the image forming apparatus 101.

In Sq801, the CPU 301a of the image forming apparatus 101 controls the communication I/F 305a to send data including a communication establishment request and the own ID (identification information of the image forming apparatus 101) on the communication bus. This ID may be alternatively referred to as communication address. The communication bus connects with the image forming apparatus 101, the inserter 102, and the finisher 103. Accordingly, the data and ID are transmitted to all the post-processing apparatuses that are connected to the communication bus. The CPU 301b of the inserter 102 receives the data and ID by the communication I/F 305b. Similarly, the CPU 301c of the finisher 103 receives the data and ID by the communication I/F 305c as well.

In Sq802, the CPU 301b of the inserter 102 controls the communication I/F 305b to send data including a connection request and the ID of the inserter 102 to the image forming apparatus 101. The CPU 301a of the image forming apparatus 101 receives the ID and data sent from the inserter 102 by the communication I/F 305a. Note that the configuration information of the inserter 102 may be included in the connection request, or may be sent following the connection request. The CPU 301a stores the configuration information of the inserter 102 in the RAM 303a.

In Sq803, the CPU 301a of the image forming apparatus 101 controls the communication I/F 305a to send the ID of the image forming apparatus 101 and data indicating a successful reception of the connection request to the inserter 102.

In Sq804, the CPU 301c of the finisher 103 controls the communication I/F 305c to send data including a connection request and the ID of the finisher 103 to the image forming apparatus 101. The CPU 301a of the image forming apparatus 101 receives the ID and data sent from the finisher 103 by the communication I/F 305a. Note that the configuration information of the finisher 103 may be included in the connection request or may be sent following the connection request. The CPU 301a stores the configuration information of the finisher 103 in the RAM 303a.

In Sq805, the CPU 301a of the image forming apparatus 101 controls the communication I/F 305a to send the ID of the image forming apparatus 101 and data indicating a successful reception of the connection request to the finisher 103.

FIG. 8B illustrates a signal sequence in the image forming system 100 being not connected (not activated) with the image forming apparatus 101 and connected with the inserter 102 and the finisher 103. Here, it is assumed that the inserter 102 has been activated by the mechanical switch SW1. The CPU 301b of the inserter 102 determines whether data including a communication establishment request from the image forming apparatus 101 within a predetermined period of time have been received. The CPU 301b, if unable to receive the data including a communication establishment request from the image forming apparatus 101 within the predetermined period of time, determines that the image forming apparatus 101 is not connected to the upstream side of the inserter 102 (non-activated), and performs the following sequence. The CPU 301b sets the inserter 102 to the master. On the other hand, the CPU 301c sets the finisher 103 to the slave.

In Sq811, the CPU 301b of the inserter 102 controls the communication I/F 305b to send data including a communication establishment request and the own ID (identification information of the inserter 102) on the communication bus. The CPU 301c of the finisher 103 receives the data and ID by the communication I/F 305c.

In Sq812, the CPU 301c of the finisher 103 controls the communication I/F 305c to send data including a connection request and the ID of the finisher 103 to the inserter 102. The CPU 301b of the inserter 102 receives the ID and data sent from the finisher 103 by the communication I/F 305b. Note that the configuration information of the finisher 103 may be included in the connection request or may be sent following the connection request. The CPU 301b stores the configuration information of the finisher 103 in the RAM 303b.

### Flowchart

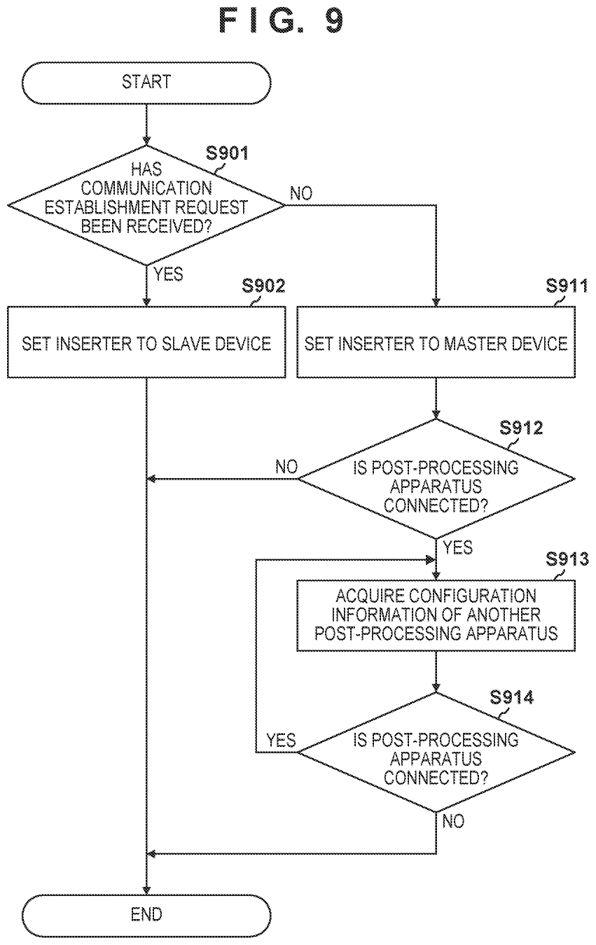

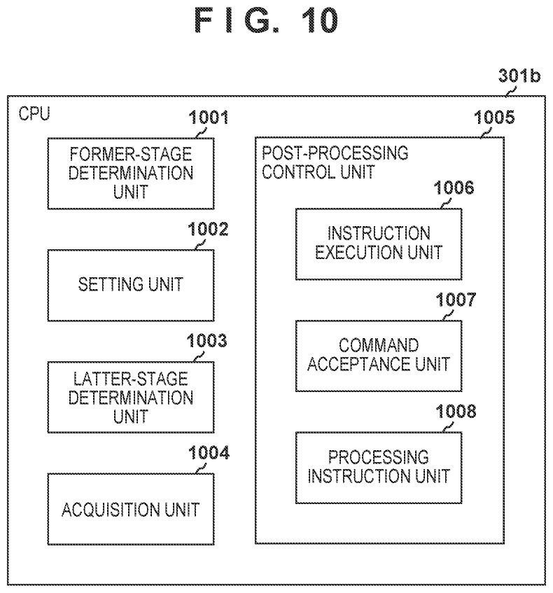

FIG. 9 illustrates an activation processing performed by the CPU 301b of the inserter 102. Upon input of the power source remote signals Sr1 and Sr2 and activation of the CPU 301b, the CPU 301b performs the following activation processing. FIG. 10 illustrates functions realized by an execution of a program by the CPU 301b.

In S901, the CPU 301b (former-stage determination unit 1001) determines whether a communication establishment request from the image forming apparatus 101 has been received. The CPU 301b, when the communication establishment request from the image forming apparatus 101 has been received, causes the process to proceed to S902. On the other hand, the CPU 301b, when the communication establishment request from the image forming apparatus 101 has not been received, causes the process to proceed to S911. As such, the CPU 301b functions as the former-stage determination unit 1001 or includes the former-stage determination unit 1001.

In S902, the CPU 301b (setting unit 1002) sets the inserter 102 to the slave device (slave mode). This allows the CPU 301b to operate as a downstream device of the image forming apparatus 101. That is, the CPU 301b controls the load section 307b in accordance with a processing instruction that is sent from the image forming apparatus 101. As such, the CPU 301b functions as the setting unit 1002 of the slave device or includes the setting unit 1002.

In S911, the CPU 301b (the setting unit 1002) sets the inserter 102 to the master device (master mode). This allows the CPU 301b to operate as a master device in place of the image forming apparatus 101. That is, the CPU 301b controls the load section 307b in accordance with the processing instruction that is input from the operation unit 306b. In the master mode, the CPU 301b sends a processing instruction to another post-processing apparatus connected to the downstream side of the inserter 102 and controls of the another post-processing apparatus. As such, the CPU 301b functions as the setting unit 1002 of the master device or includes the setting unit 1002.

In S912, the CPU 301b (latter-stage determination unit 1003) determines whether another post-processing apparatus is connected to the downstream side of the inserter 102. For example, the latter-stage determination unit 1003 controls the communication I/F 305b to send a communication establishment request. The latter-stage determination unit 1003, which sends the data including the communication establishment request and the ID of the inserter 102 on the communication bus, determines that another post-processing apparatus is connected to the downstream side when having received a response signal from a post-processing apparatus at downstream-side (e.g., the finisher 103) within a predetermined period of time. In this case, the CPU 301b causes the process to proceed to S913. The response signal includes the ID of the another post-processing apparatus and data including the connection request. On the other hand, the latter-stage determination unit 1003, when failed to receive the response signal from the post-processing apparatus at downstream-side (e.g., the finisher 103) within a predetermined period of time, determines that another post-processing apparatus is not connected to the downstream side. In this case, the CPU 301b terminates the activation processing. As such, the CPU 301b functions as the latter-stage determination unit 1003 or includes the latter-stage determination unit 1003.

In S913, the CPU 301b (acquisition unit 1004) acquires configuration information of the another post-processing apparatus. The acquisition unit 1004 acquires the configuration information from the data received from the another post-processing apparatus. Alternatively, the acquisition unit 1004 may acquire the configuration information of the another post-processing apparatus by sending data including a sending request of the configuration information to the another post-processing apparatus. The configuration information may include type information indicating types of post-processing processes that the another post-processing apparatus can perform. Note that in case when a plurality of other post-processing apparatuses are being connected, the acquisition unit 1004 counts the number of the plurality of other post-processing apparatuses, and stores the counting result in the RAM 303b. As such, the CPU 301b functions as the acquisition unit 1004 of acquiring the configuration information or includes the acquisition unit 1004.

In S914, the CPU 301b (the latter-stage determination unit 1003) determines whether still another post-processing apparatus is connected. The latter-stage determination unit 1003 controls the communication I/F 305b to send a communication establishment request. The latter-stage determination unit 1003, when the response signal from the post-processing apparatus at downstream-side is received (e.g., another post-processing apparatus connected to the downstream side of the finisher 103) within a predetermined period of time, determines that still another post-processing apparatus is connected to the downstream side. In this case, the CPU 301b causes the process to proceed to S913. In S913, the CPU 301b acquires configuration information of the still another post-processing apparatus. On the other hand, the latter-stage determination unit 1003, when failed to receive the response signal from the still another post-processing apparatus within a predetermined period of time, determines that the still another post-processing apparatus is not connected. In this case, the CPU 301b terminates the activation processing. As such, the CPU 301b acquires configuration information from all the post-processing apparatuses connected to the downstream side of the inserter 102.

As illustrated in FIG. 10, the CPU 301b may include a post-processing control unit 1005. An instruction execution unit 1006 controls sheet insertion processing and inspection processing of the inserter 102 in accordance with an instruction received from the image forming apparatus 101. A command acceptance unit 1007 may allow the operation unit 306b to display post-processing processes that can be performed by the inserter 102 or the finisher 103 in accordance with the configuration information. The command acceptance unit 1007 may also allow the user to select post-processing processes through the operation unit 306b. A processing instruction unit 1008 generates a processing instruction for performing the post-processing processes selected by the user and sends the processing instruction. For example, the processing instruction unit 1008, when the execution of the inspection processing is commanded, instructs the instruction execution unit 1006 to perform feeding of a sheet and to cause the inspection apparatus 123 to execute an inspection. The instruction execution unit 1006 causes the feeding roller 124 to rotate to transport a sheet on which the inspection is to be performed to the inspection apparatus 123. The instruction execution unit 1006 activates the inspection apparatus 123 to perform an inspection on the sheet. The processing instruction unit 1008 may receive the inspection result from the inspection apparatus 123 and cause the operation unit 306b to display the inspection result. On the other hand, the processing instruction unit 1008, when the execution of the punching processing is commanded, generates a patch processing instruction and sends the patch processing instruction to the finisher 103 through the communication I/F 305b. The processing instruction unit 1008 also instructs the instruction execution unit 1006 to perform feeding of a sheet. The instruction execution unit 1006 causes the feeding roller 124 to rotate to transport a sheet on which the punching processing is to be performed to the inspection apparatus 123.

As such, even when the image forming apparatus 101 is not activated, the post-processing apparatus such as the inserter 102 or the finisher 103 is enabled to be activated alone (stand alone). Further, even when the image forming apparatus 101 is asleep, the post-processing apparatus such as the inserter 102 or the finisher 103 is enabled to be activated and usable. Moreover, even when the image forming apparatus 101 is not connected, the post-processing apparatus such as the inserter 102 or the finisher 103 is enabled to be activated and usable.

### Technical Concept Derived from Examples

As described above, the inserter 102 and the finisher 103 are an example of the post-processing apparatus that can be connected to the image forming apparatus 101. The signal input terminal 402b is an example of an inputting unit into which a first activation signal (e.g., the power source remote signal Sr1) that is output from the image forming apparatus 101 is input. The mechanical switch SW1 is an example of a user switch to be operated by the user. The generation circuitry 421 is an example of a generating unit provided inside the post-processing apparatus, and configured, by turning on the user switch, to generate a second activation signal (e.g., the power source remote signal Sr2) corresponding to the first activation signal. The DC power source 403b is an example of a power source unit configured to be activated in response to the first activation signal that is input into the inputting unit or the second activation signal generated by the generating unit. The sheet insertion mechanism and the inspection apparatus 123 of the inserter 102 is an example of the post-processing unit configured to perform a post-processing process on a sheet using an electric power supplied from the power source unit. The power source circuitry is activated, when the image forming apparatus is in a state of being unable to output the first activation signal, in response to the second activation signal generated by the generation circuitry. As such, generating the second activation signal equivalent to the first activation signal enables the post-processing apparatus to be activated even when the image forming apparatus 101 is not activated. For example, even when the image forming apparatus 101 is not connected to the inserter 102, or the image forming apparatus 101 is not activated, the inserter 102 is enabled to be activated. Further, even in a case where the image forming apparatus 101, which is in an electric power saving state, cannot output the power source remote signal Sr1, the inserter 102 is enabled to be activated.

The post-processing apparatus may have a first operation mode and a second operation mode. The first operation mode is a mode in which, when the image forming apparatus 101 is in a state of being able to output the first activation signal, the power source unit is activated in accordance with the first activation signal, and the post-processing apparatus operates in cooperation with the image forming apparatus 101. Operations of the post-processing apparatus in cooperation with the image forming apparatus 101 include an operation of the post-processing apparatus in accordance with the processing instruction that is output from the image forming apparatus 101. The second operation mode is a mode in which, when the image forming apparatus 101 is in a state of being unable to output the first activation signal, the power source unit is activated in accordance with the second activation signal and the post-processing apparatus operates without cooperating with the image forming apparatus 101.

As illustrated in FIG. 4, the alternating-current power source 408 is an example of an alternating-current input unit. The DC power source 403b is an example of a conversion unit configured to convert the alternating current that is input into the alternating-current input unit into a direct current. The relay RL1 is an example of a first switch for switching, in accordance with the first activation signal and the second activation signal, between a connected state where the alternating-current input unit is connected to the conversion unit and a non-connected state where the alternating-current input unit is not connected to the conversion unit. The first switch is configured to not connect the alternating-current input unit and the conversion unit if none of the first activation signal and the second activation signal have been input. The first switch is configured to connect the alternating-current input unit and the conversion unit if the first activation signal or the second activation signal has been input.

The mechanical switch SW1 is an example of a second switch for switching between a connected state where the alternating-current input unit is connected to the generating unit, and a non-connected state where the alternating-current input unit is not connected to the generating unit. The generation circuitry 421 is configured, upon being connected to the alternating-current input unit via the second switch, to generate the second activation signal using an alternating current supplied from the alternating-current input unit and to supply the second activation signal to the first switch. The generation circuitry 421 is configured, when not connected to the alternating-current input unit via the second switch, to not generate the second activation signal. Note that the generation circuitry 421 may be an AC/DC conversion circuitry configured to convert the alternating current that is input into the alternating-current input unit into a direct current.

The signal output terminal 401b is an example of an outputting unit from which the first activation signal is output to another post-processing apparatus (e.g., the finisher 103) connected to the post-processing apparatus. The diode D2 is an example of a first rectification unit configured to output the first activation signal that is input from the inputting unit to the outputting unit, and to not output the first activation signal applied to the outputting unit from the another post-processing apparatus, to the inputting unit. This suppresses a signal from flowing back from the post-processing apparatus at downstream-side to the post-processing apparatus at upstream-side.

The signal output terminal 401b may be configured to output the second activation signal to another post-processing apparatus connected to the post-processing apparatus. The diode D2 may be configured to output the second activation signal to the output terminal.

The diode D3 is an example of a second rectification unit provided between the generating unit and the power source unit, and configured to apply the second activation signal generated by the generating unit to the power source unit, and to not apply the first activation signal that is input from the inputting unit to the generating unit. This allows for a protection of the generation circuitry 421.

The signal input terminal 402b may be connected to the anode of the first rectification unit, the cathode of the second rectification unit, the control terminal of the first switch, and the signal input unit of the power source unit. That is, the anode of the first rectification unit is connected to the cathode of the second rectification unit. The cathode of the first rectification unit is connected to the signal output terminal 401b. Accordingly, the second activation signal is supplied to the signal output terminal 401b via the second rectification unit and the first rectification unit. As such, the first rectification unit may output the second activation signal to the outputting unit to activate the another post-processing apparatus. This allows the post-processing apparatus at upstream-side to be able to activate the post-processing apparatus at downstream-side even when the image forming apparatus 101 is in a state of being unable to output the first activation signal.

The communication I/F 305b is an example of the communication unit communicating with the image forming apparatus 101 and the another post-processing apparatus. The CPU 301b and the former-stage determination unit 1001 function as a determining unit for determining whether the image forming apparatus 101 is connected to the post-processing apparatus on the basis of attempting to communicate with the image forming apparatus 101 via the communication unit. As described above, the CPU 301b may determine whether the image forming apparatus 101 is connected to the inserter 102 on the basis of whether to have received the communication establishment request from the image forming apparatus 101. The CPU 301b instruction execution unit 1006, in accordance with a determination of the determining unit that the image forming apparatus 101 is connected to the post-processing apparatus, functions as an instruction unit that executes an instruction received from the image forming apparatus 101 via the communication unit. The CPU 301b and the processing instruction unit 1008, in accordance with a determination of the determining unit that the image forming apparatus 101 is not connected to the post-processing apparatus, function as an instruction unit that sends an instruction to the another post-processing apparatus in place of the image forming apparatus 101. This allows the post-processing apparatus at upstream-side to be able to control the post-processing apparatus at downstream-side.

The CPU 301b and the former-stage determination unit 1001 may function as a determining unit for determining whether the image forming apparatus 101 is activated, on the basis of whether to be able to communicate with the image forming apparatus 101 via the communication unit. The CPU 301b and the instruction execution unit 1006, in accordance with a determination of the determining unit that the image forming apparatus 101 is activated, execute an instruction received from the image forming apparatus 101 via the communication unit. The CPU 301b and the processing instruction unit 1008, in accordance with a determination of the determining unit that the image forming apparatus 101 is not activated, send an instruction for controlling the another post-processing apparatus to the another post-processing apparatus, in place of the image forming apparatus 101.

The CPU 301b and the former-stage determination unit 1001 may function as a determining unit configured to determine whether to have received the connection request (communication establishment request) from the image forming apparatus 101 via the communication unit. The CPU 301b and the instruction execution unit 1006, in accordance with a determination of the determining unit that the connection request has been received from the image forming apparatus 101, execute an instruction received from the image forming apparatus 101 via the communication unit. The CPU 301b and the processing instruction unit 1008, in accordance with a determination of the determining unit that the connection request has not been received from the image forming apparatus 101, send an instruction for controlling the another post-processing apparatus to the another post-processing apparatus, in place of the image forming apparatus 101.

The CPU 301b, in accordance with a determination of the determining unit that the connection request has not been received from the image forming apparatus 101, may send the connection request to the another post-processing apparatus. The CPU 301b may be configured to receive configuration information of another post-processing apparatus from the another post-processing apparatus, and to send an instruction according with the configuration information to the another post-processing apparatus.

As illustrated in FIG. 7A, the image forming apparatus 101, the post-processing apparatus, and the another post-processing apparatus may be bus-connected. The operation unit 306b and the command acceptance unit 1007 may function as an accepting unit configured to accept setting information for setting a post-processing process to be performed by the post-processing unit. The CPU 301b and the processing instruction unit 1008 may function as a control unit configured to control the post-processing unit in accordance with the setting information having been accepted by the accepting unit.

The inserter 102 is an example of a first post-processing apparatus that is connectable to the image forming apparatus 101. The finisher 103 is an example of a second post-processing apparatus connected to the first post-processing apparatus. The signal output terminal 401a is an example of a first output unit from which the first activation signal for activating the first post-processing apparatus is output. The signal input terminal 402b is an example of a first input unit into which the first activation signal that is output from the image forming apparatus 101 is input. The DC power source 403b is an example of a first power source unit configured to be activated in response to the first activation signal that is input into the first input unit or the second activation signal generated by the generating unit. The sheet insertion mechanism and the inspection apparatus 123 of the inserter 102 is an example of a first post-processing unit configured to perform a post-processing process on a sheet using an electric power supplied from the first power source unit. The signal output terminal 401b is an example of a second output unit configured to output the first activation signal or the second activation signal to the second post-processing apparatus. The signal input terminal 402c is an example of the second input unit into which the first activation signal or the second activation signal that is output from the first post-processing apparatus is input. The DC power source 403c is an example of a second power source unit configured to be activated in response to the first activation signal or the second activation signal that is input into the second input unit. The stapler 136, the punching unit 134, and the like are an example of a second post-processing unit configured to perform a post-processing process on a sheet using an electric power supplied from the second power source unit.

The diode D1 is an example of the rectification unit configured to regulate the second activation signal flowing from the first post-processing apparatus, through the first output unit, into the image forming apparatus 101. This may allow the image forming apparatus 101 to be protected from the second activation signal.

The invention is not limited to the above embodiments, and various modifications and variations are possible without departing from the spirit and scope of the invention. Accordingly, claims are appended for the purpose of publicizing the scope of the invention.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-155686, filed Aug. 22, 2018 which is hereby incorporated by reference herein in its entirety.

What is claimed is:

1. A post-processing apparatus connectable to an image forming apparatus, the post-processing apparatus comprising:
an input terminal into which a first activation signal output from the image forming apparatus is input;
a user switch to be operated by a user;
a generation circuitry provided inside the post-processing apparatus, the generation circuitry being configured, by turning on the user switch, to generate a second activation signal corresponding to the first activation signal;
a power source circuitry activated in response to the first activation signal input into the input terminal; and
a post-processing mechanism configured to perform a post-processing process on a sheet using an electric power supplied from the power source circuitry, wherein
when the image forming apparatus is in a state of being unable to output the first activation signal, in response to the second activation signal generated by the generation circuitry, the power source circuitry is activated.

2. The post-processing apparatus according to claim 1, wherein
the post-processing apparatus has
a first operation mode in which, when the image forming apparatus is in a state of being able to output the first activation signal, the power source circuitry is activated in accordance with the first activation signal and the post-processing apparatus operates in cooperation with the image forming apparatus, and
a second operation mode in which, when the image forming apparatus is in a state of being unable to output the first activation signal, the power source circuitry is activated in accordance with the second activation signal and the post-processing apparatus operates without cooperation with the image forming apparatus.

3. The post-processing apparatus according to claim 1, further comprising:
an alternating-current input unit;
a conversion circuitry provided in the power source circuitry, the conversion circuitry being configured to convert an alternating current input into the alternating-current input unit into a direct current; and
a first switch for switching, in accordance with the first activation signal and the second activation signal, between a connected state where the alternating-current input unit is connected to the conversion circuitry, and a non-connected state where the alternating-current input unit is not connected to the conversion circuitry, wherein
the first switch is configured:
to not connect the alternating-current input unit to the conversion circuitry if none of the first activation signal and the second activation signal have been input, and
to connect the alternating-current input unit to the conversion circuitry if the first activation signal or the second activation signal has been input.

4. The post-processing apparatus according to claim 3, wherein
the user switch includes a second switch for switching between a connected state where the alternating-current input unit is connected to the generation circuitry, and a non-connected state where the alternating-current input unit is not connected to the generation circuitry, wherein
the generation circuitry is configured,
upon being connected to the alternating-current input unit via the second switch, to generate the second activation signal using the alternating current supplied from the alternating-current input unit and to supply the second activation signal to the first switch,
and, when the alternating-current input unit is not connected to the generation circuitry via the second switch, to not generate the second activation signal.

5. The post-processing apparatus according to claim 4, wherein
the generation circuitry is an AC/DC conversion circuitry configured to convert an alternating-current input into the alternating current input unit into a direct current.

6. The post-processing apparatus according to claim 1, further comprising:
an output terminal from which the first activation signal is output into another post-processing apparatus connected to the post-processing apparatus; and
a first rectification element configured to output the first activation signal input from the input terminal to the output terminal, and to not output the first activation signal applied to the output terminal from the another post-processing apparatus, to the input terminal.

7. The post-processing apparatus according to claim 6, wherein
the output terminal is configured to output the second activation signal to the another post-processing apparatus connected to the post-processing apparatus, wherein
the first rectification element is configured to output the second activation signal to the output terminal.

8. The post-processing apparatus according to claim 6, further comprising:
a second rectification element provided between the generation circuitry and the power source circuitry, and configured to apply the second activation signal generated by the generation circuitry to the power source circuitry, wherein
the second rectification element is provided between the generation circuitry and the input terminal so as not to apply the first activation signal input from the input terminal, to the generation circuitry.

9. The post-processing apparatus according to claim 8, wherein
an anode of the second rectification element is connected to the generation circuitry,
a cathode of the second rectification element is connected to an anode of the first rectification element, and
a cathode of the first rectification element is connected to the output terminal, wherein
the generation circuitry is configured to output the second activation signal to the output terminal via the second rectification element and the first rectification element to activate the another post-processing apparatus.

10. The post-processing apparatus according to claim 1, further comprising:
a communication circuitry configured to communicate with the image forming apparatus and another post-processing apparatus;
a determination circuitry configured to determine whether the image forming apparatus is activated, based on whether to be able to communicate with the image forming apparatus via the communication circuitry; and
an instruction circuitry configured, in accordance with a determination of the determination circuitry that the image forming apparatus is activated, to execute an instruction received from the image forming apparatus via the communication circuitry, and configured, in accordance with a determination of the determination circuitry that the image forming apparatus is not activated, to send an instruction for controlling the another post-processing apparatus to the another post-processing apparatus in place of the image forming apparatus.

11. The post-processing apparatus according to claim 10, wherein
the determination circuitry determines whether the image forming apparatus is activated based on whether a communication establishment request from the image forming apparatus has been received.

12. The post-processing apparatus according to claim 11, wherein
the communication circuitry is configured, in accordance with a determination of the determination circuitry that a communication establishment request has not been received from the image forming apparatus, to send a communication establishment request to the another post-processing apparatus, to receive configuration information of the another post-processing apparatus from the another post-processing apparatus, and to send an instruction according with the configuration information to the another post-processing apparatus.

13. The post-processing apparatus according to claim 10, wherein
the image forming apparatus, the post-processing apparatus, and the another post-processing apparatus are bus-connected.

14. The post-processing apparatus according to claim 1, further comprising:
an acceptance circuitry configured to accept setting information for setting a post-processing process to be performed by the post-processing mechanism, and
a control circuitry configured to control the post-processing mechanism in accordance with the setting information having been accepted by the acceptance circuitry.

15. An image forming system, the image forming system comprising an image forming apparatus and a first post-processing apparatus connectable to the image forming apparatus, wherein
the image forming apparatus includes a first output terminal from which a first activation signal for activating the first post-processing apparatus is output, wherein
the first post-processing apparatus includes
a first input terminal into which the first activation signal output from the image forming apparatus is input,
a user switch to be operated by a user,
a generation circuitry provided inside the first post-processing apparatus and configured, by turning on the user switch, to generate a second activation signal corresponding to the first activation signal,
a first power source circuitry configured to be activated in response to the first activation signal input into the first input terminal or the second activation signal generated by the generation circuitry, and
a first post-processing mechanism configured to perform a post-processing process on a sheet using an electric power supplied from the first power source circuitry, wherein
the power source circuitry is configured to be activated, when the image forming apparatus is in a state of being unable to output the first activation signal, in response to the second activation signal generated by the generation circuitry.

16. The image forming system according to claim 15, wherein
the image forming system further comprises a second post-processing apparatus connected to the first post-processing apparatus, wherein
the first post-processing apparatus includes
a second output terminal from which the first activation signal or the second activation signal is output to the second post-processing apparatus;
wherein
the second post-processing apparatus includes
a second input terminal into which the first activation signal or
the second activation signal output from the first post-processing apparatus is input,
a second power source circuitry configured to be activated in response to the first activation signal or the second activation signal input into the second input terminal, and
a second post-processing mechanism configured to perform a post-processing process on a sheet using an electric power supplied from the second power source circuitry.

17. The image forming system according to claim 15, wherein
the image forming apparatus further includes a first rectification element configured to regulate the second activation signal flowing from the first post-processing apparatus, through the first output terminal, into the image forming apparatus.

18. The image forming system according to claim 16, wherein
the first post-processing apparatus further includes a second rectification element configured to regulate a signal flowing from the second post-processing apparatus, through the second output terminal, into the first post-processing apparatus.
